(19) United States
(12) Patent Application Publication
(10) Pub. No.: US 2013/0330690 A1
(43) Pub. Date: Dec. 12, 2013

(54) DENTAL VENEER PRODUCT

(71) Applicants: Glenn Svensson, Save (SE); Daniel Melin, Goteborg (SE)

(72) Inventors: Glenn Svensson, Save (SE); Daniel Melin, Goteborg (SE)

(73) Assignee: NOBEL BIOCARE SERVICES AG, Zurich-Flughafen (CH)

(21) Appl. No.: 13/978,699

(22) PCT Filed: Jan. 10, 2012
(86) PCT No.: PCT/EP2012/000078

§ 371 Date: Aug. 28, 2013

(30) Foreign Application Priority Data
Jan. 11, 2011 (GB) 1100423.1
Jan. 20, 2011 (GB) 1100968.5

(51) Int. Cl. A61C 5/10

(52) U.S. Cl. CPC A61C 5/10
USPC 433/219; 433/223; 433/218

(57) ABSTRACT

Certain embodiments relate to a method of forming an individualized dental product ready for application including at least one tooth veneer, which is of a ceramic material. The method includes milling a first side of a ceramic substrate, filling up with a support material against the first side of the substrate, and milling the second side of the substrate until the veneer is plate-like and provided with a bevelled region over a distance (s) taken from an edge and 0.3 mm to 3 mm towards a middle portion of the veneer. The veneer thickness varies from 0 to a plate thickness (d*enlargement factor) over the distance (s). The method further includes sintering the dental product and removing the support material. Certain embodiments also relate to a product resulting from the method.

### CROSS-REFERENCE TO RELATED APPLICATIONS

This application is a national stage application under 35 U.S.C. §371 of PCT Application No. PCT/EP2012/000078, filed on Jan. 10, 2012, which published in English as WO 2012/095297 A1 on Jul. 19, 2012 and which claims priority benefit of GB Patent Application No. 1100423.1, filed on Jan. 11, 2011, and GB Patent Application No. 1100968.5, filed on Jan. 20, 2011, the entire contents of which applications and publication are herein incorporated by reference in their entireties.

### BACKGROUND

1. Field of the Invention

The present invention relates to a dental product comprising at least one veneer. In dentistry, a veneer is a thin layer of restorative material placed over a tooth surface, to improve the aesthetics of the tooth. Consequently, the invention is also related to a method for manufacture of the dental product.

2. Description of the Related Art

US 2009/0004629 A1 describes a tooth veneer in the form of a dental arch laminate which can be made of plastic, such as durable, injection-molded plastic, or a veneer form of plastic. These dental arch laminates are configured for comfortable and reusable application to a person's teeth. The arch laminates are fitted and adhered using a non-toxic tackification adhesive, which is not a bonding agent, cement, or other semi-permanent adhesive. Rather, the non-toxic tackification adhesive is temporary and reusable, such that a person can easily reapply the non-toxic tackification adhesive, for instance, for daily use.

The known veneers discussed above are made of a polymer. This allows the veneer to have a thickness from approximately 0.1 mm and more, up to 0.9 mm.

US 2005/0227204 A1 describes a reusable veneer for temporary use, which can be removed by the use of a warm water rinse in the mouth and pulling the veneer off from the teeth. These temporary veneers can be made of porcelain, plastic, other semi-rigid composite materials, or combinations thereof. These veneers can be made from 0.2 mm to about 1 mm in thickness.

None of the above-described veneers require preparation and pre-shaping of a tooth, including cutting, drilling, grinding and other forms of permanently removing material from a tooth. It is understood that these veneers can thus be applied to non-prepared teeth. This is generally regarded as advantageous as irreversible alterations are often a traumatic experience for a person and may require pain-killing shots to be used prior to the procedure. This would also increase costs of the application of a veneer.

Clearly, a non-invasive or minimally invasive application of a veneer has a huge psychological advantage over application of a veneer, which requires permanent removal of tooth material.

Although the temporary veneers are certainly very useful, many people still find the need to apply, remove and re-apply veneers inconvenient, time-consuming, and they dislike the risk of forgetting to apply and/or to have at hand the necessary materials to apply the veneer. Also, temporary veneers provide relatively poor aesthetics. Hence, there is a need for providing a permanent veneer, which does not require any traumatic invasive preparation of the selected tooth, but yet capable of fulfilling the other needs associated with a veneer. It is desirable to also shorten the number of visits to a clinic for such a treatment.

### SUMMARY

The above objects are achieved or alleviated by certain embodiments which include an individualized dental product ready for application comprising, at least one tooth veneer which is of a ceramic material, said veneer is plate-like and, over its major part, has a thickness (d) between a first side and a second side, wherein said thickness is at least about 0.08 mm, wherein the plate thickness is less than 0.2 mm, less than 0.14 mm or less than 0.1 mm characterized in that said veneer has a bevelled region over a distance (s) taken from an edge and 0.3 mm to 3 mm towards a middle portion of said veneer, wherein the veneer thickness varies from close to 0 to said plate thickness (d) over said distance (s).

Further advantages and preferred embodiments include a dental product wherein each of the at least one tooth veneer is individually designed to match a part of a predetermined tooth that is to be covered by that veneer.

Preferably, at least one veneer is individually designed to correspond to a part of a non-prepared tooth that is to be covered by that veneer.

Advantageously, the ceramic material is translucent, such as zirconium oxide to enable good esthetical result.

More preferably, the product comprises a plurality of tooth veneers.

The at least one tooth veneer comprises a pre-treated bonding material, such as an at least partially cured bonding material cured before application to a tooth.

Advantageously, the bonding material comprises at least one colouring material and the at least one tooth veneer is at least partially transparent or translucent.

Suitably, the bevelled region, as seen in cross section of said veneer, describes a curved path. More preferably or suitably in the dental product according to certain embodiments, the distance (s) of the bevelled region is about 0.4 mm from the edge of the veneer.

Furthermore the above objects are achieved or alleviated by certain embodiments which include a method for forming an individualized dental product ready for application comprising, at least one tooth veneer, which is of a ceramic material, said method comprising the step of: milling a first side of a ceramic substrate, milling being controlled by CAD/CAM, filling up with a support material against the first side of said substrate, milling the second side of said substrate until said at least one veneer is plate-like and provided with a bevelled region over a distance (s) taken from an edge and 0.3 mm to 3 mm towards a middle portion of said veneer, wherein the veneer thickness varies from 0 to a plate thickness d*enlargement factor over said distance (s), sintering said dental product and removing said support material. The removal of the support material can be performed after or before sintering. Sintering temperatures for the ceramic material used are well known in the art and not repeated here.

Preferably, the pores of the support material 8 have a pore diameter less than 0.05 mm. More preferably, the pore diameter should be less than 10% of the aligning surface of the milling tool. It was found that in some embodiments, the combination of relatively large sized pores and thin plate thickness should be avoided in order for the material not to collapse. Advantageously, the support material 8 used is wax. In order to achieve an almost non-porous or aligning support material the surface of the ceramic substrate is preheated to a surface temperature below 80 degrees C., more precisely between 40 and 70 degrees C., preferably between 55 and 65 degrees C. The wax is then attached to the ceramic substrate to give best possible support. It is furthermore preferable to use. Suitably the milling is performed on a pre-sintered ceramic substrate. This makes the milling operation cost and time efficient and yet the resulting product is of high quality. Other substrates or blanks can be used if considered suitable.

In addition and contrary to normal procedure the milling of the second side is performed from the edge of the veneer and inwards of said veneer. It was discovered that using the steps of starting milling from outside and moving inwards of the veneer to be worked on the edges became sharp and further helped in that the material did not collapse.

### BRIEF DESCRIPTION OF THE DRAWINGS

Certain embodiments will further be explained with reference to the drawings, in which:

FIG. 1 shows a set of teeth and an example of a veneer in accordance with certain embodiments;

FIG. 2 shows a single tooth and an example of a veneer in accordance with certain embodiments,

FIG. 3 shows the tooth and veneer shown in FIG. 2, wherein the veneer is placed onto the tooth;

FIG. 4 shows a three dimensional representation of a tooth and steps for making an example of a dental product in accordance with certain embodiments;

FIG. 5 shows schematically in cross section one example of a dental product in accordance with certain embodiments;

FIG. 6 shows schematically in cross section an alternative example of a dental product in accordance with certain embodiments;

FIGS. 7a-7c shows an intermediate result of production process steps during manufacturing of an example of a dental product in accordance with certain embodiments;

FIG. 8 shows use of an assembly for temporarily holding an example of a dental product in accordance with certain embodiments;

FIG. 9 shows schematically and in cross section an assembly for temporarily holding an example of a dental product in accordance with certain embodiments; and

FIG. 10 shows schematically a top view of the assembly shown in FIG. 9 without its container lid, as viewed in the direction of arrow A1.

### DETAILED DESCRIPTION

Specific embodiments will now be described with reference to the accompanying drawings. This disclosure may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Each of the Figures shows a complete assembly, or a part of such an assembly, of a dental product and a holding system for temporarily holding the dental product. Advantages of an assembly according to certain embodiments are most pronounced in assemblies where the dental product concerns a fragile product. An example of such a fragile dental product is a veneer. Such a veneer may also be referred to as a laminate. In the following, reference will be made only to a veneer, which should not be construed as limiting. A laminate is also embraced by the term veneer.

Within the dentistry world, a veneer is a thin layer of restorative material placed over a tooth surface, to improve the aesthetics of the tooth. Where the improvement only concerns an improvement of the color of a predetermined tooth, the veneer can be very thin. In some embodiments, the veneer may be made of a glass ceramic. Particularly, such a thin veneer will be fragile and difficult to handle without breaking it. Furthermore, in some embodiments, the veneer or laminate is a non-framework dental product, i.e. the veneer or laminate is placed directly on to a tooth surface without any intermediate framework to strengthen the laminate or veneer. Other dental prostheses, such as a dental crown or bridge may include a veneering layer on top of a framework, such as a coping or bridge framework, wherein the veneering layer is applied in several layers on top of the framework or coping and subsequently sintered. However, in general, such a veneer on top of a framework does not suffer from strength issues and is not particularly fragile to handle.

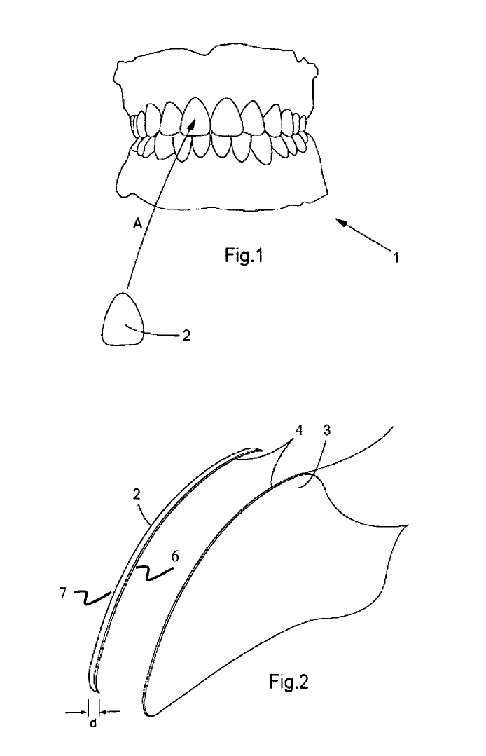

FIG. 1 shows a set of teeth 1 as well as a dental product 2, in this example being one tooth veneer 2. Such a veneer may also be referred to as a laminate. In the following, reference will be made only to a veneer, which should not be construed as limiting. The term veneer also embraces a laminate, an inlay or onlay. Arrow A shows where the tooth veneer 2 is intended to be placed within the set of teeth 1. The veneer 2 is ready for application in the sense that no further re-shaping of the veneer 2 has to take place. The veneer 2 concerns an individualized dental product. The veneer 2 has characteristics, which are related to the characteristics of a tooth of a person. One side (the back surface) of the veneer is designed to match the tooth 3 it is meant to cover. The veneer 2 bears, as such, features, which correspond to features of an individual, namely the person for whom the veneer 2 is designed. Given that match, there will not be a need to remove material from the tooth 3.

For certain embodiments, it is described that it is not necessary to remove material from the tooth. In other embodiments, small portions of a tooth may be prepared, e.g. by grinding. This may be done e.g. to remove imperfections of a tooth surface. However, it is not intended that an entire surface, such as a front surface of a tooth, is prepared by grinding, e.g. since the veneer is sufficiently thin to not cause discomfort for the person wearing the veneer 2.

The veneer 2 may be individually designed to correspond to at least a part of the tooth 3, which is meant to be covered by the veneer 2. The tooth 3 as covered with the veneer 2 will increase its thickness by the layer of veneer 2, and by a very thin layer of bonding material 4 which is placed between the veneer 2 and the tooth 3 for bonding the veneer 2 to the tooth 3.

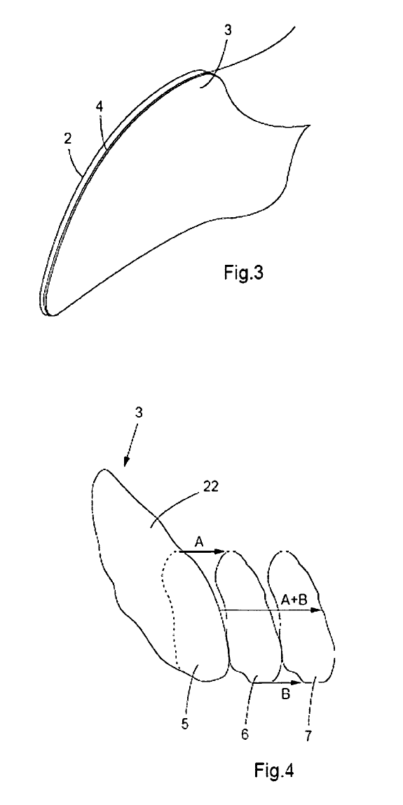

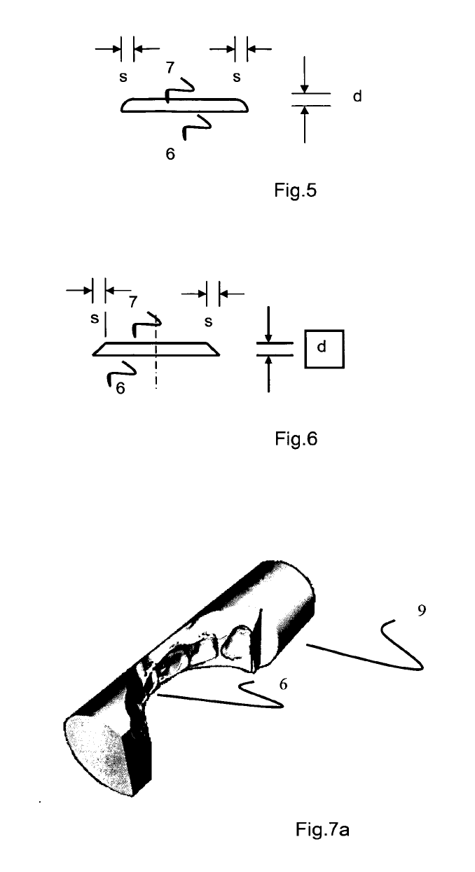

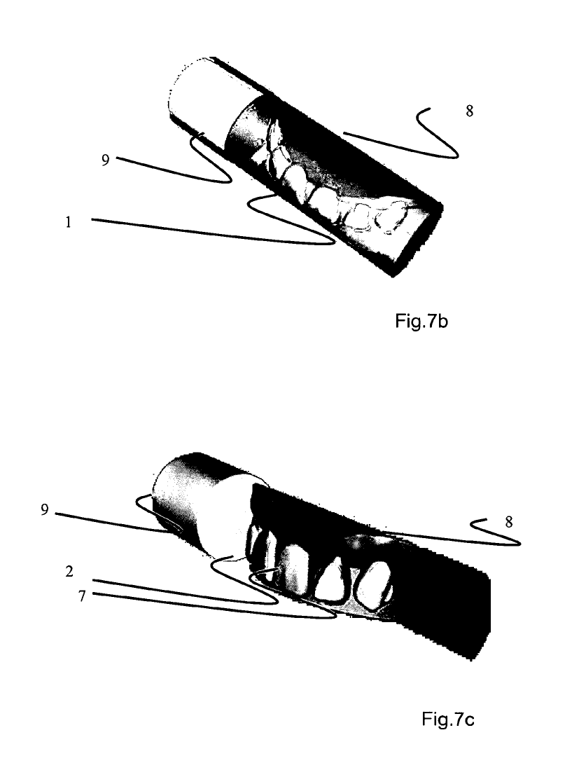

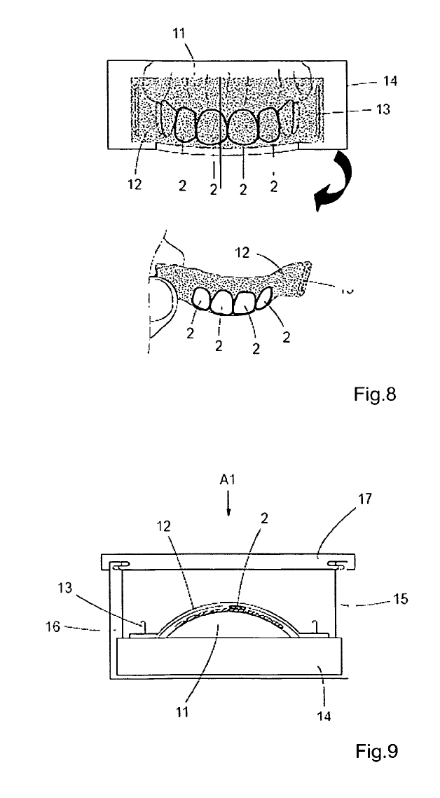

FIG. 2 shows a cross-sectional view of a tooth 3, which is to be covered by the veneer 2. For applying the veneer 2 to the tooth 3, surfaces of the veneer 2 and the tooth 3 facing each other in that application may each be etched in order to provide clean surfaces. This is normal standard practice, routinely carried out by a dental practitioner. The etching may be followed by applying a silanization layer to each of the surfaces. Also this concerns a standard practice, routinely carried out by a dental practitioner. The silanization layer provides a sealing to the etched surface. After this, a thin layer of bonding material 4 can be applied to each of these surfaces, i.e. to the veneer 2 and the tooth 3. This bonding material 4 can be provided with a color agent (not shown). The veneer 2 is then applied to the tooth 3 to end up with a tooth 3 covered by veneer 2 and bonding material 4, as shown in FIG. 3. It is to be noted that, effectively, no tooth material has been removed from tooth 3. Hence, the veneer 2 is applied to a so-called “non-prepared” tooth. The veneer 2 is individually designed to correspond to a part of a non-prepared tooth 3 that is covered by the veneer 2. The bonding may be further facilitated by light-curing, as is well known in the art.

In some embodiments, the tooth veneer 2 is pre-treated with a bonding material before application onto the person's tooth and possibly even before delivery to the dental practitioner applying the tooth veneer 4. Using conventional veneers, the bonding material is typically applied to the tooth 3 onto which the veneer is to be applied, the veneer is then placed on that tooth, and the bonding material cured, such as by light curing. According to some embodiments, the bonding material is at least partly applied to the tooth veneer 2, such as 25-75% of the total bonding material to be used for bonding the tooth veneer 2. The pre-treatment can be carried out at the production facility of the tooth veneer 2 or by a dental technician. The pre-treatment of at least one side of the tooth veneer, such as the backside facing the tooth 3, may comprise at least one of the following steps: cleaning of the tooth veneer; application of etching gel for preparing a chemical and/or mechanical connection surface; providing etched surface prepared for sealing with silane as transport protection; applying a silanization process for obtaining a silanized surface; application of at least one layer of bonding material 4 on top of the silanized surface; application of coloring material, such as for cervical and/or incisal colorings, before, on top of, or mixed in the bonding material; applying the bonding material to the tooth veneer 2; and light curing the bonding material 4 for delivery to the dental practitioner.

Some embodiments may also comprise pre-treatment by the practitioner of the tooth to receive the tooth veneer 2. The pre-treatment by the practitioner may comprise at least one of the following steps: cleaning the non-prepared (i.e. substantially non-ground front surface) surface of the tooth 3, such as with isopropanol; etching of the tooth surface, such as with etching gel, e.g. fluoride etching gel, fluoride hydrogen etching gel etc.; silanization of the etched tooth surface; and application of the remainder of the bonding material 4, such as 25-75% if 25-75% was applied to the tooth veneer, onto the tooth surface to end up with a total of 100% of required bonding material. The bonding material applied to the tooth surface may have a neutral color, such as transparent or white, whereby appearance provided by the coloring added to the veneer 2 is substantially not affected.

Some embodiments may also comprise at least one of the following steps for a veneering procedure: providing pre-treated veneer 2 with hardened bonding material; applying the tooth veneer onto the tooth surface comprising bonding material 4; adjusting the veneer 2; and curing, such as by light curing, the connection between the surfaces with bonding material 4.

Using certain embodiments of the pre-treating procedure, the veneer 2 may comprise a pre-treated bonding material. The pre-treated bonding material 4 may comprise an at least partially cured bonding material 4, such as a light curable dental bonding agent. The pre-treated bonding material may comprise at least one coloring material to color the veneer 2. Hence, due to the thinness of the veneer 2 in combination with its translucency the coloring of the bonding material 4 will be visible. Therefore, application of a separate coloring layer is not necessary.

As can easily be seen in FIGS. 2 and 3, the veneer 2 is plate-like in certain embodiments. In various embodiments, the veneer 2 has a plate thickness “d” of at least about 0.08 mm. Ideally, in some embodiments, the plate thickness “d” is less than 0.1 mm. In some embodiments, the plate thickness “d” will be less than 0.2 mm. In some embodiments, it is more preferable that the thickness “d” of the veneer is less than 0.14 mm. The plate thickness “d” in various embodiments, is a mean thickness. At various portions the veneer 2 may be thinner or thicker. For example, the veneer 2 may comprise various structures to look more natural, such as grooves or furrows. Additionally or alternatively, the tooth veneer may comprise a texture at the front surface for a more natural look of the veneer 2 or to recreate a lost feature of a person's dentition, e.g. due to abrasion. It is also thinner in some embodiments at the border of the veneer 2. In some embodiments, the veneer has a bevelled region over a distance (s) taken from an edge and 0.3 mm to 3 mm towards a middle portion of said veneer, wherein the veneer thickness 2 varies from 0 to said plate thickness (d) over said distance (s). Preferably, the bevelled region, as seen in cross section of said veneer 2, describes a curved path. In some embodiments, thee ceramic substrate comprises zirconia oxide.

In a dental product according to certain embodiments, the distance (s) of the bevelled region is about 0.4 mm from the edge of the veneer.

In certain embodiments, it has advantageously shown that the preferred ranges of the thickness is sufficiently thin to not cause discomfort to the person wearing the veneer 2 without removing tooth material and yet provide sufficient strength of the tooth veneer.

Furthermore, in certain embodiments, the veneer 2 or laminate is a non-framework dental product, i.e. the veneer or laminate is placed directly on to a tooth surface without any intermediate framework to strengthen the laminate or veneer. Other dental prosthesis, such as a dental crown or bridge, or even some ceramic veneers, may include a veneering layer on top of a framework, such as a coping or bridge framework, wherein the veneering layer is applied in several layers on top of the framework or coping and subsequently sintered. However, in general, such a veneer 2 on top of a framework does not suffer from strength issues and is not particularly fragile to handle.

In certain embodiments, the veneer 2 is of a ceramic material, which is preferably translucent. Obtaining a desired color of a tooth 3 can more easily be obtained at the “placement site” by adding a color agent to the bonding material 4 and then applying the translucent ceramic veneer 2, so that the color agent can contribute to the appearance of tooth 3, in terms of its color.

The ceramic material may be a glass ceramic material, such as a Li-disilicate glass ceramic. Li-disilicate glass ceramic has a high strength, which provides for improved possibilities to handle the fragile product. Alternatively, the ceramic material may comprise a microwave sintered aluminum oxide ceramic. Such materials are particularly useful in combination with a veneer having a thickness within the ranges of some embodiments.

In some embodiments, the veneer 2 comprises a single layer of glass-ceramic having uniform composition. Optionally, non-ceramic coloring and/or glazing layers may be added at least on one side of the veneer 2.

The treatment of a patient can be performed according to the following steps. During a first visit to a clinic the diagnosis and treatment planning can be made. The patient may be provided with virtual and photographic examples of veneer cases to illustrate the likely result of the treatment. A partial or full arch impression of the patient's mouth is taken using preferred technology and used to create a CAD/CAM model. The model will be generated taking into account any possible tooth reduction associated to the treatment. Depending on skill the model is done after a second visit when tooth reduction and a new model of the dental situation are performed.

Before the final visit the generated CAD file is used for producing the veneer or set of veneer. See further sections for more details of the method to produce the veneers. The produced veneers are preferably sent to a lab for final porcelain veneering/characterization and glaze, together with the kit of components for placing the veneer/veneers. The dentist receives the kit with the finished veneers and tries with different cement shades. After agreement with the patient the veneers are positioned.

An individualized dental product 2 ready for application, such as a ceramic veneer 2, can be produced as follows.

For designing the veneer 2, use can be made of computer-readable tooth data, which represent a predetermined tooth for which the veneer 2 is designed. These data can be obtained by a standard method, using standard systems, well known in the art and widely available. For example, such methods may comprise scanning of an impression or a cast model based on the impression to obtain the computer-readable data. On the basis of the computer-readable tooth data it is possible to produce on a display a three-dimensional representation 22 of the predetermined tooth 3 for which the veneer 2 is designed. Standard tools within an dental CAD program enable visualizing the three dimensional representation 22 as seen from a different angle, after rotation, as zoomed in, as zoomed out, as fully transparent etc. Although ideally the complete predetermined tooth 3 is shown, it is possible that only a part of the predetermined tooth 3 is shown.

On the basis of the three-dimensional representation 22 in certain embodiments, computer-readable veneer data are provided for determining the geometry of the veneer. FIG. 4 shows schematically how this can be done. In the three-dimensional representation 22 a selected tooth part 5 is defined. The selected tooth part 5 is to be covered by the veneer 2. The selected tooth part 5 can, for instance, be defined by providing with the cursor a line, such as a finish line, in the three-dimensional representation of the predetermined tooth 3 for which the veneer 2 is designed. In a standard way, it can be confirmed to the computer that the line, closed in itself, defines indeed the selected tooth part 5. On the basis of the selected tooth part 5, a back surface 6 of the veneer 2 is defined. On the basis of the selected tooth part 5, a front surface 7 of the veneer 2 is defined. Defining the back surface may comprise copying the selected tooth part 5. Defining the front surface 7 may also comprise copying (directly or indirectly) the selected tooth part 5. Defining the back surface 6 of the veneer 2 can be based on a reproduction of the selected tooth part visualized in a three-dimensional representation 22, possibly with an offset (A), e.g. to provide space for the bonding material 4. Likewise, defining the front surface 7 of the veneer 2 can be based on a reproduction of the selected tooth part 5, or a reproduction of the back surface 6, visualized in the three-dimensional representation 22 with an offset (A+B, B), wherein B represents the thickness of the veneer 2, relative to the selected tooth part 5 and/or to the back surface 6. Having defined the back surface 6 and the front surface 7, it is possible to define according to a predetermined program a connection between edges of the back surface 6 and edges of the front surface 7. In any case, by this method it is possible to obtain computer-readable veneer data, defining the geometry of the veneer 2.

### Method

Certain embodiments include a method for forming an individualized dental product 2 ready for application comprising, at least one tooth veneer 2, which is of a ceramic material, said method comprising the step of: milling a first side of a ceramic substrate, milling being controlled by CAD/CAM, filling up with a support material 8 against the first side of said substrate, milling the second side of said substrate until said at least one veneer 2 is plate-like and provided with a bevelled region over a distance (s) taken from an edge and 0.3 mm to 3 mm towards a middle portion of said veneer, wherein the veneer thickness 2 varies from 0 to a plate thickness d*enlargement factor over said distance (s), sintering said dental product 2 and removing said support material 8. The removal of the support material can be performed after or before sintering. Sintering temperatures for the ceramic material used are well known in the art and not repeated here.

Preferably, the pores of the support material 8 have a pore diameter less than 0.05 mm. More preferably, the pore diameter should be less than 10% of the aligning surface of the milling tool. It was found that in some embodiments, the combination of relatively large sized pores and thin plate thickness should be avoided in order for the material not to collapse. Advantageously, the support material 8 used is wax. In order to achieve an almost non-porous or aligning support material the surface of the ceramic substrate is preheated to a surface temperature below 80 degrees C., more precisely between 40 and 70 degrees C., preferably between 55 and 65 degrees C. The wax is then attached to the ceramic substrate to give best possible support. It is furthermore preferable to use. Suitably the milling is performed on a pre-sintered ceramic substrate. This makes the milling operation cost and time efficient and yet the resulting product is of high quality. Other substrates or blanks can be used if considered suitable.

In addition and contrary to normal procedure the milling of the second side is performed from the edge of the veneer and inwards of said veneer. It was discovered that using the steps of starting milling from outside and moving inwards of the veneer to be worked on the edges became sharp and further helped in that the material did not collapse.

### Positioning

The releasable bonding may be provided by, e.g., vacuum bonding, electrostatic bonding, and/or an adhesive bonding film. Vacuum bonding can be provided by a thermo-forming unit, wherein a deformable blank is pre-heated, positioned on top of the first part with the veneer 4 in-between and deformed by activation of a vacuum pump, whereby the blank releasably bonds to the veneer 2, which is supported by the first part 11. Then, the deformed blank can be trimmed to a desired shape. Such vacuum forming apparatus is available from, e.g., Dreve, Germany, under the tradenames Vacformat U, Vacformat 2000 and Druformat Scan. Bonding films, such as electrostatic foils or films, films with adhesives, both resin based and light curing based, etc. are available, from, e.g., 3M, USA.

It will be possible that on separating the second part 12 from the first part 11, each of the tooth veneers as bonded to the second part 12 is manually transferred to the front teeth to which the veneers 2 have to be applied. It is then possible to attach each of the veneers 2 individually, by applying bonding material 4 only to one predetermined tooth or corresponding tooth veneer 2 at a time, or applying bonding material 4 to each of the tooth veneers 2 simultaneously, therewith reducing “chair time” and improving the probability that the veneer 2 is applied without disturbing the relative position to one another. A dental product 2 as described above, comprising one or more tooth veneers 2, on application onto predetermined teeth 3, improves the aesthetics of these teeth 3. Although it is very possible that the application can occur as described above, and with the use of the second part 12, the foil with grasp holders 13, as a handling and placement tool, it is also possible that a dental practitioner rather makes use of tools having suction cups and/or vacuum tweezers for handling such a thin veneer. A method of improving the aesthetics of the tooth, may comprise placing a dental product 2 as described above, and may further comprise the use of a bonding material 4 to which a color agent has been added.

### Container

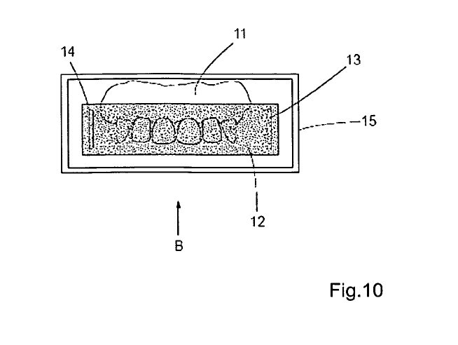

FIGS. 9 and 10 show schematically two cross sections of an embodiment wherein the model is associated with the support 14 for supporting the model. FIG. 10 shows a top view of the example shown in FIG. 9 (without a container lid) as viewed in the direction of arrow A in FIG. 9. FIG. 9 shows a cross section viewed in the direction of arrow B in FIG. 10. Support 14 and the model are positionally fixed relative to each other. In the embodiment shown, the first part 11 concerns a single piece part, i.e. the support 14 and the model are integrally connected to each other. However, it is also possible that the support 14 and the model are two separate parts, which are fixed or fixable to each other. The assembly schematically shown in FIGS. 9 and 10 further comprises a container 15. The support 14 has dimensions for holding the model stable in the container 15. The container 15 may for that purpose for instance internally be provided with a shoulder 16 under which edges of the support 14 can be clamped. The material of the container 15 may be made of a thermoplastic, which allows for slight bending of parts of the container. This would allow for placing the support 14 as shown in FIG. 9 and for closing the container 14 with a container lid 17 by means of a clamping mechanism or snap-fit, or any other mechanism known in the art for providing a closed container 15.

The disclosure is not limited to the embodiments discussed above. Many modifications and different embodiments are possible. Each of these is understood to fall within the framework of the invention, as defined by the appended claims.

1. A method of forming an individualized dental product ready for application comprising,
at least one tooth veneer of a ceramic material, said method comprising:
milling a first side of a ceramic substrate, milling being controlled by CAD/CAM,
filling up with a support material against the first side of said substrate,
milling a second side of said substrate until said at least one veneer is plate-like and provided with a bevelled region over a distance (s) taken from an edge about 0.3 mm to about 3 mm towards a middle portion of said veneer, wherein the veneer thickness varies from 0 to a plate thickness (d*enlargement factor) over said distance (s),
sintering said dental product, and
removing said support material.

2. The method according to claim 1, wherein pores of the support material have a pore diameter less than about 0.05 mm.

3. The method according to claim 1, wherein the support material is wax.

4. The method according to claim 1, wherein a surface of the ceramic substrate is preheated to a surface temperature below about 80 degrees C.

5. The method according to claim 1, wherein the milling is performed on a pre-sintered ceramic substrate.

6. The method according to claim 1, wherein the milling of the second side is performed from the edge of the veneer and inwards of said veneer.

7. A dental product obtainable by performing the method according to claim 1.

8. An individualized dental product ready for application comprising
at least one tooth veneer of a ceramic material,
said veneer is plate-like and, over its major part, has a thickness (d) between a first side and a second side, wherein said thickness is at least about 0.08 mm, wherein the plate thickness is less than about 0.2 mm, wherein
said veneer has a bevelled region over a distance (s) taken from an edge and about 0.3 mm to about 3 mm towards a middle portion of said veneer, wherein the veneer thickness varies from 0 to said plate thickness (d) over said distance (s).

9. The dental product according to claim 8, wherein at least one tooth veneer is individually designed to match a part of a predetermined tooth that is to be covered by that veneer.

10. The dental product according to claim 8, wherein the at least one veneer is individually designed to correspond to a part of a non-prepared tooth that is to be covered by that veneer.

11. The dental product according to claim 8, wherein the ceramic material is translucent.

12. The dental product according to claim 8, wherein the product comprises a plurality of tooth veneers.

13. The dental product according to claim 8, wherein the at least one tooth veneer comprises a pre-treated bonding material.

14. The dental product according to claim 13, wherein the bonding material comprises at least one colouring material and the at least one tooth veneer is at least partially transparent or translucent.

15. The dental product according to claim 8, wherein the bevelled region, as seen in cross section of said veneer, describes a curved path.

16. The dental product according to claim 8, wherein said distance (s) of the bevelled region is about 0.4 mm from the edge of the veneer.

17. (canceled)

18. A method of improving the aesthetics of a tooth, wherein the method comprises placing a dental product according to claim 8 onto a tooth surface.

19. The method according to claim 4, wherein the surface temperature is between about 40 degrees C. and about 70 degrees C.

20. The method according to claim 19, wherein the surface temperature is between about 55 degrees C. and about 65 degrees C.

21. The dental product according to claim 8, wherein the plate thickness is less than about 0.14 mm.

22. The dental product according to claim 21, wherein the plate thickness is less than about 0.1 mm.

23. The dental product according to claim 13, wherein the pre-treated bonding material comprises an at least partially cured bonding material cured before application to a tooth.
